(19) United States
(12) Patent Application Publication
(10) Pub. No.: US 2026/0040404 A1
(43) Pub. Date: Feb. 5, 2026

(54) SELF-REGULATING HEATING CABLES WITH EMBEDDED DIELECTRIC LAYER

(71) Applicant: nVent Services GmbH, Schaffhausen (CH)

(72) Inventors: Paul Becker, San Carlos, CA (US); Dong Yu, Fremont, CA (US); Victor Del Valle, Fremont, CA (US); Prasad Raut, Sunnyvale, CA (US)

(21) Appl. No.: 19/287,610

(22) Filed: Jul. 31, 2025

Related U.S. Application Data
(60) Provisional application No. 63/677,893, filed on Jul. 31, 2024.

(51) Int. Cl. H05B 1/02; H05B 3/56

(52) U.S. Cl. CPC H05B 1/0202; H05B 3/565

(57) ABSTRACT

A self-regulating heating cable and production methods are provided. The self-regulating heating cable includes a core, first and second conductive wires, a primary jacket, a ground plane, and a final jacket. A dielectric band is embedded within the core, and the first conductive wire and the second conductive wire are embedded within the core and separated by the dielectric band. The dielectric band includes substantially flat upper and lower edges between the first conductive wire and the second conductive wire, and protrusions extending outward from the substantially flat upper and lower edges. The primary jacket surrounds the core, the ground plane surrounds the primary jacket and provides a ground path, and the final jacket surrounds the ground plane.

### CROSS REFERENCE TO RELATED APPLICATIONS

This application claims priority to U.S. Provisional Application No. 63/677,893, filed on Jul. 31, 2024, the contents of which is incorporated by reference herein in its entirety.

### BACKGROUND

Heater cables, such as self-regulating heater cables, tracing tapes, and other types, are cables configured to provide heat in applications requiring such heat. Heater cables offer the benefit of being field-configurable. For example, heater cables may be applied or installed as needed without the requirement that application-specific heating assemblies be custom-designed and manufactured, though heater cables may be designed for application-specific uses in some instances.

In some approaches, a heater cable operates by use of two or more bus wires having a high conductance coefficient (i.e., low resistance). The bus wires are coupled to differing voltage supply levels to create a voltage potential between the bus wires. A positive temperature coefficient (PTC) material can be situated between the bus wires and current is allowed to flow through the PTC material, thereby generating heat by resistive conversion of electrical energy into thermal energy. As the temperature of the PTC material increases, so does its resistance, thereby reducing the current therethrough and, therefore, the heat generated via resistive heating. The heater cable is thus self-regulating in terms of the amount of thermal energy (i.e., heat) output by the cable.

### SUMMARY

Some embodiments provide a self-regulating heating cable including a core comprising a positive temperature coefficient material, a band of dielectric material embedded within the positive temperature coefficient material, and a first conductive wire and a second conductive wire embedded within the core and separated by the band of dielectric material. The band of dielectric material includes substantially flat upper and lower edges between the first conductive wire and the second conductive wire, and protrusions extending outward from the substantially flat upper and lower edges. The self-regulating heating cable further comprises a primary jacket surrounding the core, a ground plane surrounding the primary jacket and providing a ground path, and a final jacket surrounding the ground plane.

Some embodiments provide a self-regulating heating cable including a core comprising a positive temperature coefficient material, a band of dielectric material embedded within the positive temperature coefficient material, and a first conductive wire and a second conductive wire embedded within the core and separated by the band of dielectric material. The core includes indentations formed therein extending from its outer surface toward the band of dielectric material. The self-regulating heating cable further comprises a primary jacket surrounding the core, a ground plane surrounding the primary jacket and providing a ground path, and a final jacket surrounding the ground plane.

Some embodiments provide a method of producing a self-regulating heating cable for use with an alternating current (AC) source. The method includes assembling a band of dielectric material between a first conductive wire and a second conductive wire, where the band of dielectric material includes substantially flat upper and lower edges between the first conductive wire and the second conductive wire, and protrusions extending outward from the substantially flat upper and lower edges. The method further includes assembling a positive temperature coefficient core material over the band of dielectric material, the first conductive wire, and the second conductive wire such that the first conductive wire, the second conductive wire, and the band of dielectric material are embedded within the positive temperature coefficient core material. The positive temperature coefficient material creates electrical paths for conducting current between the first conductive wire and the second conductive wire when the first conductive wire and the second conductive wire are connected to the AC source. The method further includes applying a primary jacket over the positive temperature coefficient material, applying a ground plane over the primary jacket, and applying a final jacket over the ground plane.

### DESCRIPTION OF THE DRAWINGS

FIG. 1 is a cross-sectional view of a self-regulating heater cable according to some embodiments.

FIG. 2 is an isometric cutaway view of the self-regulating heater cable of FIG. 1.

FIG. 3 is an isometric cutaway view of a self-regulating heater cable according to some embodiments.

FIG. 4 is a cross-sectional view of the self-regulating heater cable of FIG. 3, excluding one or more layers of the self-regulating heater cable.

FIG. 5 is a cross-sectional view of another self-regulating heater cable according to some embodiments.

FIG. 6 is a cross-sectional view of yet another self-regulating heater cable according to some embodiments.

FIG. 7 is a cross-sectional view of yet another self-regulating heater cable according to some embodiments.

FIG. 8 is a method for a manufacturing self-regulating heater cable according to an example implementation.

FIG. 9 is another method for a manufacturing self-regulating heater cable according to an example implementation.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

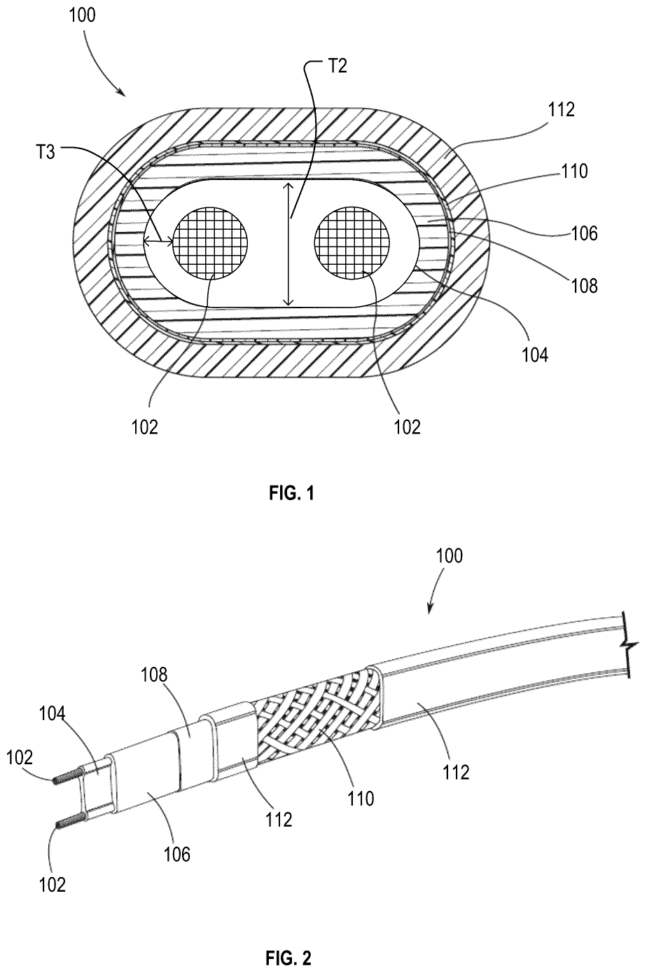

FIGS. 1 and 2 illustrate a self-regulating heating cable 100. As shown in FIGS. 1 and 2, the cable 100 can include parallel conductor wires 102, a core 104, a primary jacket 106, an optional barrier layer 108, a ground plane 110 (such as, but not limited to, a wire braid, a wire wrap, and/or a foil wrap), and a final jacket 112. The conductor wires 102 can be made of nickel-coated copper and are surrounded by the core 104 (e.g., a semi-conductive polymer material). For example, the core 104 can be extruded over and/or between the conductor wires 102 so that the wires 102 are embedded within and separated by the core 104. In this manner, the core 104 is considered to have a monolithic design, e.g., as opposed to a fiber-wrapped design in which a self-regulating heating element is wrapped around the wires 102. The core 104 can be surrounded by the primary jacket 106, which can be an electrically insulating polymer compound. On top of the primary jacket 106, the optional barrier layer 108 can act as a barrier for the interior components (e.g., protecting them from water and/or chemicals). The barrier layer 108 can be a metallic foil, such as aluminum foil. The ground plane 110 (e.g., a tinned-copper or other metallic braid or wrap) then surrounds the aluminum foil barrier layer 108 or the primary jacket 106 and acts as a ground path. On top of the ground plane 110, the final jacket 112 acts as a mechanical protection layer.

With further reference to the core 104, in some embodiments, the core 104 can be a positive temperature coefficient (PTC) material comprising one or more polymers, such as polyolefin-based polymer or fluoropolymer, mixed with conductive carbon black or another conductive filler. This blend of materials can create electrical paths for conducting current between the parallel conductor wires 102 along the length of the cable 100 when the conductor wires 102 are connected to an alternating current (AC) source (not shown), e.g., resulting in resistive heating. Furthermore, the number of electrical paths can change in response to such heating as well as ambient temperature fluctuations. In particular, as the core temperature drops, the core 104 contracts. This contraction decreases the core's electrical resistance and creates numerous electrical paths between the wires 102. Current can then flow across these paths between the wires 102, causing the core 104 to generate heat. Conversely, as the core temperature rises, the core 104 expands, increasing electrical resistance between the wires 102 so that fewer electrical paths exist and less heat is produced.

In some cases, a power output of the cable 100 (e.g., in terms of Watts per foot, W/ft) correlates with the resistivity of the core 104, which can be set by adjusting the carbon black concentration within the polymer. For example, higher power cables 100 have lower resistivity cores 104, and lower power cables 100 have higher resistivity cores 104. More specifically, all cables 100 inherently exhibit a loading curve (e.g., resistivity versus core volume fraction of carbon in polymer composite) when observing active power versus passive power (e.g., applied voltage squared divided by resistance). The fraction of carbon black required for low-power cores 304 (e.g., less than five W/ft) occurs along this loading curve at a section where small changes in the carbon black concentration within the polymer composite results in very large changes in resistivity. On the other hand, low-resistivity cores in high-power cables (e.g., greater than five W/ft) contain a higher percentage of carbon black, placing them along the loading curve where resistivity is less sensitive to changes in composition.

In some examples, an efficiency, thermal output, and/or longevity of a cable can be manipulated by incorporating a dielectric band within a core of the cable. As described below, the dielectric band can be situated within the core between the conductor wires to disrupt a path of the current flowing through the conductive core. Incorporating the dielectric band within the core of the cable can allow for high power retention, e.g., for low wattage heating cables (such as three to five watt/foot cables). Additionally, incorporating the dielectric band may allow the use of a higher passive power conductive compound (e.g., a core with lower resistivity that includes more carbon black), which has been found to improve retention of wattage over time.

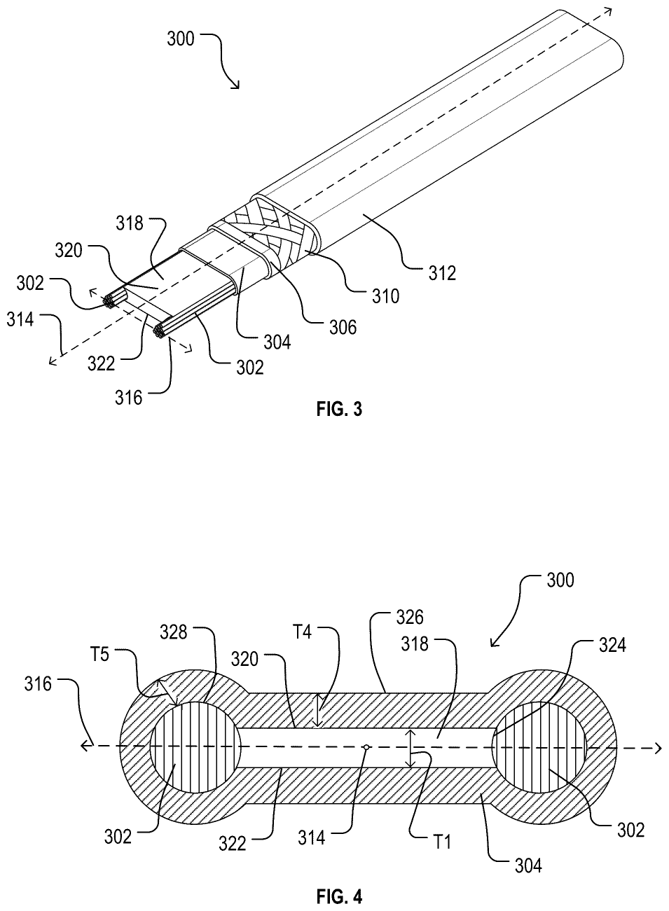

For example, FIGS. 3 and 4 illustrate a self-regulating heating cable 300 incorporating a dielectric material disposed within a core, according to some embodiments. Similar to that described above with respect to the heating cable 100 of FIG. 1, FIGS. 3 and 4 illustrate a heating cable 300 that can include parallel conductor wires 302, a core 304, a primary jacket 306, an optional barrier layer (not shown), a ground plane 310, and a final jacket 312. Accordingly, descriptions above with respect to components 102-112 of the cable 100 may equally apply to components 302-312 of the cable 300 in some embodiments. Furthermore, as shown in FIGS. 3 and 4, a longitudinal or central axis 314 can extend through a geometric center of the cable 300 along its length, e.g., from a first cable end to a second cable end. Additionally, a radial axis 316 can intersect and extend radially outward from the central axis 314 to intersect a geometric center of each of the parallel wires 302.

As shown in FIGS. 3 and 4, a dielectric band 318 can be incorporated within the core 304. More specifically, the dielectric band 318 can be disposed along the central axis 314. In some examples, the dielectric band 318 can be a band of dielectric material that extends between the parallel conductor wires 302. The dielectric band 318 can contact and/or at least partially surround a portion of each of the conductor wires 302. For example, as illustrated in FIG. 4, in some examples, the dielectric band 318 can be defined by a substantially flat first or “upper” edge 320 and a substantially flat second or “lower” edge 322 that extend between each of the wires 302. Furthermore, in some examples, the dielectric band 318 can include curved sides 324 that contact respective wires 302, wherein the curved sides 324 are shaped to match a shape of the respective wire 302. However, as described below, a shape or size of the dielectric band 318 can be chosen to customize a performance of the cable 300.

Still referring to FIG. 4, a thickness T1 of the dielectric band 318 at any point along the length of cable 300 can be measured with respect to the radial axis 316 (e.g., wherein the length of the cable 300 can be measured along the central axis 314). As illustrated in FIG. 4, the thickness T1 can be substantially constant between the wires 302. For example, the upper edge 320 and the lower edge 322 can extend substantially parallel to one another. However, as described below, the thickness T1 of the dielectric band 318 can be chosen to customize a performance of the cable 300. For example, in some embodiments, the thickness T1 of the dielectric band 318 can vary between the parallel conductor wires 302 by varying an angular offset between the upper edge 320 and the lower edge 322 (e.g., such that the upper edge 320 and the lower edge 322 are not parallel to one another) or by varying a shape of the upper edge 320 and/or the lower edge 322, as further described below.

Referring again to FIG. 4, the conductive core 304 can partially or totally surround the wires 302 and the dielectric band 318, so that the wires 302 and the dielectric band 318 are embedded within the core 304 and the wires 302 are separated by the dielectric band 318. By being “embedded” within the core 304, the core 304 can have continuous coverage surrounding both the wires 302 and the dielectric band 318 along a length of the cable 300 (e.g., as opposed to fiber-wrapped designs in which a wrapped PTC material surrounds wires 302 with gaps between the wrapped material along the length of the cable, to create non-continuous coverage along the cable length). As described above, the contact between the conductive core 304 and the wires 302 can create electrical paths for conducting current between the parallel conductor wires 302 along the length of the cable 300 when the conductor wires 302 are connected to an alternating current (AC) source (not shown), e.g., resulting in resistive heating.

As described above, a behavior of the resistive heating of the core 304 can be determined by the flow of current through the core 304. The use of the dielectric band 318 within the core 304 can disrupt a path for the flow of current between the electrical wires 302. Specifically, as the current between the wires 302 may not flow or may flow at a reduced rate through the dielectric band 318, which is positioned directly between the wires 302 along the central axis 314 and the radial axis 316, the current may be encouraged to flow through the core 304 surrounding an exterior of the wires 302 and the dielectric band 318. As such, the position of the core 304, now displaced from the central axis 314 of the cable 300, can encourage current flow and heat generation away from the central axis 314, closer to the final jacket 312. That is, concentrating a mass of the core 304 away from the central axis 314 (e.g., as compared to the design illustrated in FIG. 1) can increase a length of electrical pathways between the wires 302 and reduce an average thermal conduction distance between the conductive core 304 and the final jacket 312.

Still referring to FIG. 4, in some examples, the thickness T1 of the dielectric band 318 can determine a proximity of the core 304 to the central axis 314. For example, increasing the thickness T1 of the dielectric band 318 can displace the conductive material of the core 304 further from the central axis 314. And concentrating a mass of the conductive core 304 closer to the final jacket 312 can result in lower overall operating temperatures of the cable 300, ultimately improving a lifetime of the cable 300, by encouraging dispersion of thermal energy to the ambient environment instead of retaining the thermal energy within the cable 300. Encouraging the dispersion of thermal energy to the ambient environment, or to a component that the cable 300 is to heat, can also lead to increased efficiency of the cable 300, by reducing an amount of power required to heat the component. In other words, by generating heat closer to the ambient or the component to be heated, the cable 300 can heat the ambient or component while maintaining an overall lower operating temperature compared to the cable 100 of FIG. 1.

For example, looking back to the cable design of FIG. 1, the core 104 may extend between and fill the space between the wires 102. This results in a central thickness T2 of the core 104 between the wires 102 to be much greater than a thickness T3 of the core 104 radially outside the wires 102. As illustrated in FIGS. 3 and 4, the dielectric band 318, extending between the wires 302, can advantageously replace at least a portion of the mass of the conductive material of the core 304 within the cable 300, e.g., compared to the cable 100 of FIG. 1. That is, in some implementations, as shown in FIG. 4, a central thickness T4 of the core 304 between the wires 302 (e.g., from the upper edge 320 of the dielectric band 318 to an outer surface 326 of the core 304 or from the lower edge 322 of the dielectric band 318 to the outer surface 326) can be substantially equal to a thickness T5 of the core 304 radially outside the wires 302 (e.g., from an outer surface 328 of a wire 302 contacted by the core 304 to the outer surface 326 of the core 304). By reducing this central thickness T4 through incorporation of the dielectric band 318 within the core 304, an overall mass of the core 304 can be reduced and, as a result, the time required for the cable 300 to achieve a desired temperature and stabilize can be reduced. Furthermore, reducing the overall mass of the core 304 in this manner can also reduce in-rush or cold start up currents.

Generally, the dielectric band 318 can comprise a material with dielectric properties, such as high electric resistivity or low conductivity. Furthermore, in some examples, a material of the dielectric band 318 can be chosen to shrink or expand based on a temperature of the cable 300. For example, the material of the dielectric band 318 can be chosen from, ethylene ethyl acrylate (EEA), polyethylene (PE), high density polyethylene (HDPE), poly(ethene-co-tetrafluoroethene) (ETFE), polyvinylidene fluoride (PVDF), perfluoroakloxy alkanes (PFA), a blend of any of these materials, or any other suitable dielectric material. As another example, the material of the dielectric band 318 can comprise a polymer filled with glass or mineral materials. In some examples, properties of the material of the dielectric band 318 may permit thermal expansion of the dielectric band 318 due to an increasing temperature of the cable 300. The thermal expansion of the dielectric band 318 can result in pressure applied to the core 304 by the dielectric band 318. As described above, contraction of the core 304 can create additional electrical paths between the wires 302 by crowding the conductive fillers within the core 304, forcing the carbon particles to stay in contact with each other. That is, a conductivity of the core 304 can be pressure sensitive, and the dielectric band 318 expanding and applying pressure to the core 304 can create additional electrical paths between the wires 302 by crowding the conductive fillers within the core 304, and, consequently, encouraging the core 304 to generate heat. As a result, these additional forces applied to the core 304 by the dielectric layer 318 can result in a higher power output at a given temperature compared to, for example, the cable design of FIG. 1. Accordingly, in some embodiments, the dielectric material choice for the dielectric band 318, including characteristics such as thermal expansion rate and/or melting point, can be selected based on desired heater performance.

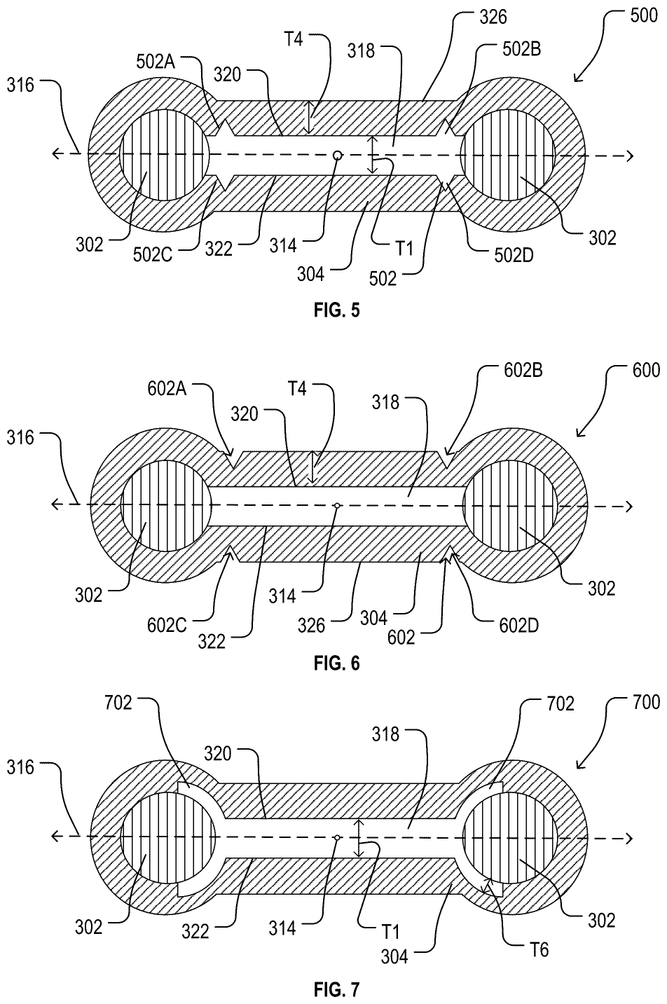

Referring now to FIG. 5, another self-regulating heating cable 500 including a dielectric band 318 is illustrated. The heating cable 500 of FIG. 5 can include similar components as those described above with respect to the heating cable 300 of FIGS. 3 and 4 and, thus, any of the description of the heating cable 300 of FIGS. 3 and 4 may equally apply to the heating cable 500 of FIG. 5, and vice versa, unless stated otherwise.

As described above, a shape and the thickness T1 of the dielectric band 318 can be chosen to customize or optimize a performance of the cable 500. In some embodiments, as illustrated in FIG. 5, the thickness T1 and the cross-sectional shape of the dielectric band 318 can vary between the parallel conductor wires 302. According to some examples, the dielectric band 318 can include protrusions 502 extending therefrom. More specifically, the protrusions 502 can extend from the upper edge 320 and/or the lower edge 322, into the core 304 and toward the final jacket 312 (e.g., radially outward from the radial axis 316). In this configuration, the protrusions 502 can locally increase a thickness of the dielectric band 318. In some embodiments, the protrusions 502 can extend an entire length of the cable 500. However, in other embodiments, the protrusions 502 may instead be discontinuous along the length of the cable 500, e.g., as spaced-apart protrusions 502 along the length. In some embodiments, the protrusions 502 can be triangular in shape, as shown in FIG. 5, however, in other embodiments, the protrusions 502 can instead be circular, semi-circular, ovular, rectangular, trapezoidal, or any other useful shape. In some embodiments, one or more of the protrusions 502 may not define the same shape.

In one example, as illustrated in FIG. 5, the dielectric band 318 can include two protrusions 502A, 502B extending from the upper edge 320 and two protrusions 502C, 502D extending from the lower edge 322. Each of the illustrated protrusions 502A-502D (alternatively referred to herein as “protrusions 502”) may be disposed adjacent the wires 302 (e.g., closer to the wires 302 than to the central axis 314). However, the protrusions 502 can instead be disposed anywhere between the wires 302. In some embodiments, each of the protrusions 502 on the upper edge 320 can be aligned with a protrusion 502 on the lower edge 322. For example, the first protrusion 502A disposed on the upper edge 320 can be radially aligned with the third protrusion 502C disposed on the lower edge 322. That is, the first protrusion 502A and the third protrusion 502C can each extend an equal radial length from the central axis 314, with the first protrusion 502A located above the radial axis 316 and the third protrusion 502C located below the radial axis 316. Accordingly, in some embodiments, a plurality of the protrusions 502 disposed on the upper edge 320 can each be radially aligned with a protrusion 502 disposed on the lower edge 322. In other words, the first protrusion 502A and the third protrusion 502C can each be located along a plane that extends perpendicular to the radial axis 316. Furthermore, the second protrusion 502B and the fourth protrusion 502D can each be located along a second plane that extends perpendicular to the radial axis 316, where the first plane and the second plane are located along opposing sides of the central axis 314. In other embodiments, the protrusions on the upper edge 320 and the lower edge 322 are instead not aligned.

In some embodiments, the protrusions 502 of the dielectric band 318 can disrupt a path of the current flowing through the conductive core 304, and encourage the current to flow around the protrusions 502. A size and shape of the protrusions 502 can, thus, be chosen to customize a performance of the cable 500 by further altering current flow paths. For example, a size of the protrusions 502 can be customized to encourage a flow of current nearer to the exterior surface 326 of the conductive core 304 and, consequently, lengthen electrical flow pathways and increase heat generation near the exterior surface 326 of the conductive core 304. Additionally, the protrusions 502 can increase a resistance of the conductive core 304, causing increased heat generation at a given voltage or current. Furthermore, in some embodiments, the protrusions 502 can facilitate easier stripping of the wires 302, when needed, for example, by forming guiding notches for a user when stripping the cable 500.

Referring now to FIG. 6, another self-regulating heating cable 600 including a dielectric band 318 is illustrated. The heating cable 600 of FIG. 6 can include similar components as those described above with respect to the heating cables 300, 500 of FIGS. 3-5, respectively, and, thus, any of the description of the heating cables 300, 500 may equally apply to the heating cable 600 of FIG. 6, and vice versa, unless stated otherwise.

As described above with respect to FIG. 5, a shape and the thickness T1 of the dielectric band 318 can be chosen to customize or optimize a performance of the cable 500 by, e.g., affecting a thickness or mass of the core 304 (i.e., the conducting layer between and/or around the cables 302). With respect to the cable 600 FIG. 6, a shape and thickness of the core 304 can also be chosen to customize or optimize a performance of the cable 600. For example, in some embodiments, as illustrated in FIG. 6, the thickness T4 and the cross-sectional shape of the core 304 can be varied. According to some examples, the core 304 can include indentations 602 extending therein. More specifically, the indentations 602 can extend from the outer surface 326 into the core 304 and toward radial axis 316. In this configuration, the indentations 602 can locally decrease a thickness of the core 304. In some embodiments, the indentations 602 can extend an entire length of the cable 600. However, in other embodiments, the indentations 602 may instead be discontinuous along the length of the cable 600, e.g., as spaced-apart indentations 602 along the length. In some embodiments, the indentations 602 can be triangular in shape, as shown in FIG. 6, however, in other embodiments, the protrusions 502 can instead be circular, semi-circular, ovular, rectangular, trapezoidal, or any other useful shape. In some embodiments, one or more of the indentations 602 may not define the same shape.

In one example, as illustrated in FIG. 6, the core 306 can include two indentations 602A, 602B extending from the outer surface 326 above the radial axis 316 and two indentations 602C, 602D extending from the outer surface 326 below the radial axis 316. Each of the illustrated indentations 602A-602D (alternatively referred to herein as “indentations 602”) may be disposed adjacent the wires 302 (e.g., closer to the wires 302 than to the central axis 314). However, the indentations 602 can instead be disposed anywhere between the wires 302. In some embodiments, each of the indentations 602 above the radial axis 314 can be aligned with an indentation 602 on below the radial axis 314. For example, the first indentation 602A disposed above the radial axis 314 can be radially aligned with the third indentation 602C disposed below the radial axis 314. That is, the first indentation 602A and the third indentation 502C can each extend an equal radial length from the central axis 314, with the first indentation 602A located above the radial axis 316 and the third indentation 602C located below the radial axis 316. Accordingly, in some embodiments, a plurality of the indentation 602 disposed above the radial axis 316 can each be radially aligned with an indentation 602 disposed below the radial axis 316. In other words, the first indentation 602A and the third indentation 602C can each be located along a plane that extends perpendicular to the radial axis 316. Furthermore, the second indentation 602B and the fourth indentation 602D can each be located along a second plane that extends perpendicular to the radial axis 316, where the first plane and the second plane are located along opposing sides of the central axis 314. In other embodiments, the indentations 602 are instead not aligned.

In some embodiments, the indentations 602, by being areas without core material, can adjust a path of the current flowing through the conductive core 304. A size and shape of the indentations 602 can, thus, be chosen to customize a performance of the cable 600 by further altering current flow paths. Additionally, the indentations 602 can increase a resistance of the conductive core 304, causing increased heat generation at a given voltage or current.

Referring now to FIG. 7, another self-regulating heating cable 700 including a dielectric band 318 is illustrated. The heating cable 700 of FIG. 7 can include similar components as those described above with respect to the heating cables 300, 500, 600 of FIGS. 3-6, respectively, and, thus, any of the description of the heating cables 300, 500, 600 may equally apply to the heating cable 700 of FIG. 7, and vice versa, unless stated otherwise.

As described above with respect to FIG. 5, a shape and the thickness T1 of the dielectric band 318 can be chosen to customize or optimize a performance of the cable 500. With respect to the cable 700 FIG. 7 in particular, a shape of the dielectric band 318 can be adjusted to substantially surround a portion of each wire 302 and, thus, affect a thickness or mass of the core 304 (i.e., the conducting layer between and/or around the cables 302). More specifically, in some embodiments, as illustrated in FIG. 7, the dielectric band 318 can include arms 702 that extend around a portion of a circumference of each wire 302, e.g., above and below the radial axis 316. In some embodiments, each arm 702 extends around at least half of a circumference of each wire 302. In other embodiments, each arm 702 extend around less than half of a circumference of each wire 302. In yet further embodiments, each arm 702 extends around more than half of a circumference of each wire 302.

In some embodiments, each arm 702 can generally include a substantially constant thickness T6. In other embodiments, each arm 702 can include a varying thickness. For example, in such embodiments, each arm 702 can include a distally tapering thickness from the central axis 314 until reaching an end point on a respective wire 302.

The dielectric band 318, comprising the arms 702 extending around portions of the wires 302, can further displace the conductive material of the core 304 further from the central axis 314, encouraging current flow and heat generation away from the central axis 314. As noted above, doing so can result in lower operating temperatures of the cable 300, ultimately improving a lifetime of the cable 300, by encouraging dispersion of thermal energy to the ambient environment instead of retaining the thermal energy within the cable 700. Encouraging the dispersion of thermal energy to the ambient environment, or to a component that the cable 700 is to heat, can also lead to increased efficiency of the cable 700, by reducing an amount of power required to heat the component.

While each of the heating cables 300, 500, 600, 700 are shown and described separately, it should be noted that features of any one cable 300, 500, 600, 700 may be combined with features of another cable 300, 500, 600, 700. That is, in some embodiments, a single cable may include a dielectric band 318 with any combination of protrusions 502, indentations 602, and/or arms 702.

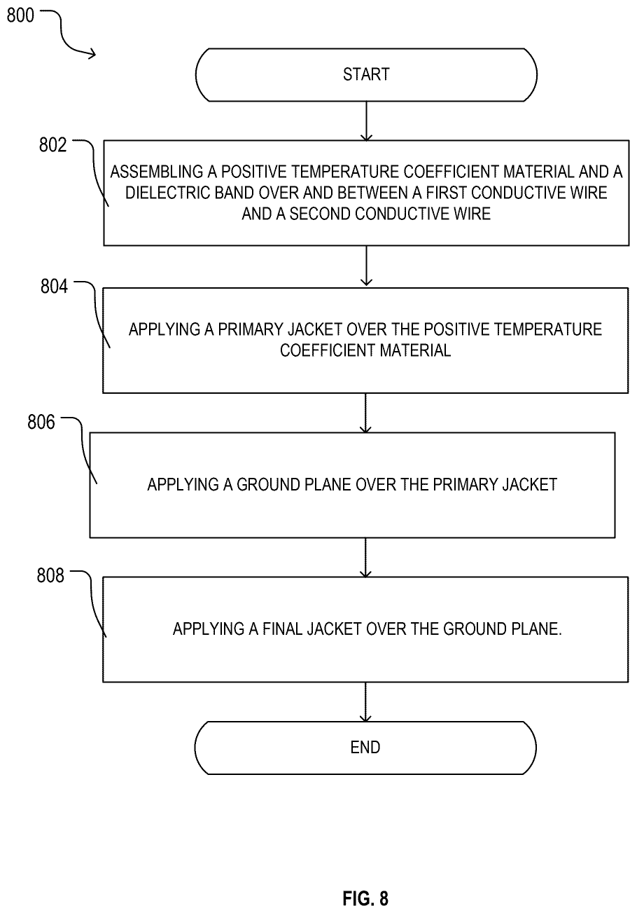

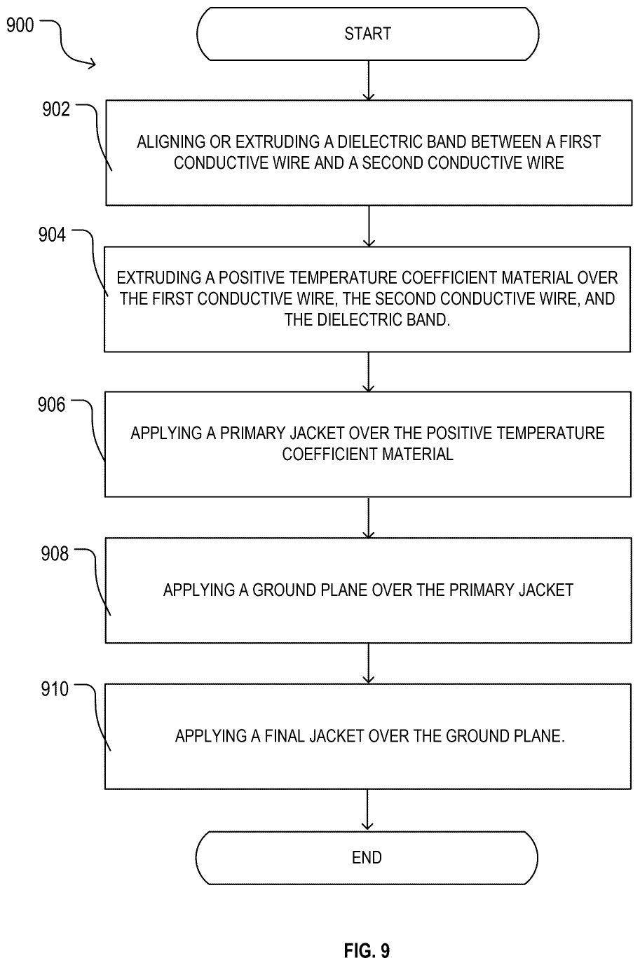

In light of the above, FIGS. 8 and 9 illustrate example methods for manufacturing a heating cable, such as any of the above-described cables 300, 500, 600, 700. It should be noted that, while each method in FIGS. 8 and 9 is shown and described as having certain method steps in a specific order, in some implementations, the method may include fewer or more steps, steps that are repeated, steps in a different order, and/or two or more steps performed simultaneously.

For example, according to one method, in some embodiments, the dielectric band 318 and the core 304 can be assembled over the wires 302, such as through co-extrusion or other suitable manufacturing methods or processes. Specifically, the dielectric band 318, the core 304, and/or other relevant layers of the cable 300 can be extruded onto the wires 302 at the same time.

Accordingly, referring to FIG. 8, an example method 800 is illustrated for manufacturing a cable. At step 802, the method 800 can include assembling a positive temperature coefficient core material 304 and a dielectric band 318 over and between a first conductive wire 302 and a second conductive wire 302. In one specific example, step 802 can include co-extruding the core material 304 and the dielectric band 318 such that the first conductive wire 302, the second conductive wire 302, and the dielectric band 318 are embedded within core material 304, and the first conductive wire 302 and the second conductive wire 302 are separated by the dielectric band 318. In some embodiments, step 802 can include using a co-extrusion head that holds the respective material layers of the core 314 and the dielectric band 318, and a die that shapes a cross-section of each material layer. In some embodiments, the co-extrusion step can ensure good contact between the wires 302 and the core 314 around the outer surface 328 of the wires 302, except for the portions in contact with the dielectric band 318.

In some embodiments, the die used in the co-extrusion process of step 802 can shape a particular cross-section of the core 314, e.g., to include indentations 602, and/or the dielectric band 318, e.g., to include protrusions 502 and/or arms 702. Alternatively or in addition, during or after step 802, the indentations 602 can be made into outer surface 326 of the core 314, e.g., via a separate punch or roller mechanism. In yet further embodiments, after step 802, the cross-section of the core 314 can be further adjusted using a punch or roller mechanism that punches through an entire thickness T4 of the core 304 at intervals along the length of the cable 300.

Referring still to FIG. 8, at step 804, the method 800 can include applying a primary jacket 306 over the core material 304. At step 806, the method 800 can include applying a ground plane 310 over the primary jacket 306. At step 808, the method 800 can include applying a final jacket 312 over the ground plane 310.

According to another method, in some embodiments, the dielectric band 318 and the core 304 can be separately applied over the wires 302. Specifically, in a first step, the dielectric band 318 can be extruded or otherwise applied relative to the wires 302 and, in a second step, the core 304 can be extruded or otherwise applied over the combination of the dielectric band 318 and the core 304.

Accordingly, referring to FIG. 9, an example method 900 is illustrated for manufacturing a cable. At step 902, the method 900 can include aligning or extruding a dielectric band 318 between a first conductive wire 302 and a second conductive wire 302. At step 904, the method 900 includes extruding a positive temperature coefficient core material 304 over the first conductive wire 302, the second conductive wire 302, and the dielectric band 318. In some embodiments, when the dielectric band 318 is extruded to create arms 702 at least partially surrounding the wires 302 during the first extrusion step 902, the arms 702 can help hold the wires 702 in place during the second extrusion step 904.

Referring still to FIG. 9, at step 906, the method 900 can include applying a primary jacket 306 over the core material 304. At step 908, the method 900 can include applying a ground plane 310 over the primary jacket 306. At step 910, the method 900 can include applying a final jacket 312 over the ground plane 310.

In the above methods 800, 900, extrusion may be pressure extrusion, vacuum extrusion, or other types of extrusion. In some embodiments, pressure extrusion may help to establish good electrical contact between the core 304 and the conductor wires 302 as the extrudate cools and shrinks onto them.

As used herein, unless otherwise defined or limited, the term “about” or “approximately” or “substantially” refers to variation in the numerical quantity that may occur, for example, through typical measuring and manufacturing procedures used for conveyor belts or other articles of manufacture that may include embodiments of the disclosure herein; through inadvertent error in these procedures; through differences in the manufacture, source, or purity of the ingredients used to make the compositions or mixtures or carry out the methods; and the like. Throughout the disclosure, the terms “about,” “approximately,” and “substantially” refer to a range of values ±310% of the numeric value that the term precedes.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A self-regulating heating cable comprising:
a core comprising a positive temperature coefficient material;
a band of dielectric material embedded within the positive temperature coefficient material;
a first conductive wire and a second conductive wire embedded within the core and separated by the band of dielectric material,
wherein the band of dielectric material includes:
substantially flat upper and lower edges between the first conductive wire and the second conductive wire, and
protrusions extending outward from the substantially flat upper and lower edges;
a primary jacket surrounding the core;
a ground plane surrounding the primary jacket and providing a ground path; and
a final jacket surrounding the ground plane.

2. The self-regulating heating cable of claim 1, wherein the band of dielectric material is made of at least one of ethylene ethyl acrylate (EEA), polyethylene (PE), poly(ethene-co-tetrafluoroethene) (ETFE), polyvinylidene fluoride (PVDF), and perfluoroakoxy alkanes (PFA).

3. The self-regulating heating cable of claim 1, wherein the band of dielectric material is made of a polymer filled with glass or mineral materials.

4. The self-regulating heating cable of claim 1, wherein the protrusions extend along a length of the band of dielectric material.

5. The self-regulating heating cable of claim 1, wherein the protrusions are discontinuous along a length of the band of dielectric material.

6. The self-regulating heating cable of claim 1, wherein the positive temperature coefficient material and the band of dielectric material are co-extruded.

7. The self-regulating heating cable of claim 1, wherein the positive temperature coefficient material is extruded over the band of dielectric material and the first conductive wire and the second conductive wire.

8. The self-regulating heating cable of claim 1, wherein the core includes indentations formed therein extending from its outer surface toward the band of dielectric material.

9. The self-regulating heating cable of claim 1, wherein the band of dielectric material includes arms that extend from the flat upper and lower edges to extend around a portion of a circumference of each of the first conductive wire and the second conductive wire.

10. A self-regulating heating cable comprising:
a core comprising a positive temperature coefficient material;
a band of dielectric material embedded within the positive temperature coefficient material;
a first conductive wire and a second conductive wire embedded within the core and separated by the band of dielectric material,
wherein the core includes indentations formed therein extending from its outer surface toward the band of dielectric material;
a primary jacket surrounding the core;
a ground plane surrounding the primary jacket and providing a ground path; and
a final jacket surrounding the ground plane.

11. The self-regulating heating cable of claim 10, wherein the band of dielectric material is made of at least one of ethylene ethyl acrylate (EEA), polyethylene (PE), poly(ethene-co-tetrafluoroethene) (ETFE), polyvinylidene fluoride (PVDF), and perfluoroakoxy alkanes (PFA).

12. The self-regulating heating cable of claim 10, wherein the band of dielectric material is made of a polymer filled with glass or mineral materials.

13. The self-regulating heating cable of claim 10, wherein the indentations extend along a length of the band of dielectric material.

14. The self-regulating heating cable of claim 10, wherein the indentations are discontinuous along a length of the band of dielectric material.

15. The self-regulating heating cable of claim 10, wherein the positive temperature coefficient material and the band of dielectric material are co-extruded.

16. The self-regulating heating cable of claim 10, wherein the band of dielectric material includes substantially flat upper and lower edges between the first conductive wire and the second conductive wire; and comprises protrusions extending outward from the substantially flat upper and lower edges.

17. The self-regulating heating cable of claim 10, wherein the band of dielectric material includes substantially flat upper and lower edges between the first conductive wire and the second conductive wire, and wherein the band of dielectric material includes arms that extend from the flat upper and lower edges to extend around a portion of a circumference of each of the first conductive wire and the second conductive wire.

18. A method of producing a self-regulating heating cable for use with an alternating current (AC) source, the method comprising:
assembling a band of dielectric material between a first conductive wire and a second conductive wire, wherein the band of dielectric material includes substantially flat upper and lower edges between the first conductive wire and the second conductive wire, and protrusions extending outward from the substantially flat upper and lower edges;
assembling a positive temperature coefficient core material over the band of dielectric material, the first conductive wire, and the second conductive wire such that the first conductive wire, the second conductive wire, and the band of dielectric material are embedded within the positive temperature coefficient core material, wherein the positive temperature coefficient core material creates electrical paths for conducting current between the first conductive wire and the second conductive wire when the first conductive wire and the second conductive wire are connected to the AC source;
applying a primary jacket over the positive temperature coefficient core material;
applying a ground plane over the primary jacket; and
applying a final jacket over the ground plane.

19. The method of claim 18, wherein assembling the band of dielectric material and assembling the positive temperature coefficient core material includes co-extruding the positive temperature coefficient core material and the band of dielectric material.

20. The method of claim 18, wherein assembling the positive temperature coefficient core material includes assembling the positive temperature coefficient core material so that the positive temperature coefficient core material includes indentations formed therein extending from its outer surface toward the band of dielectric material.
